(19) United States
(12) Patent Application Publication
(10) Pub. No.: US 2026/0329614 A1
(43) Pub. Date: Oct. 22, 2026

(54) SYNCHRONIZED LIVE MIGRATION OF COMPUTING RESOURCES

(71) Applicant: MELLANOX TECHNOLOGIES, LTD., Yokneam (IL)

(72) Inventors: Barak Biber, Haifa (IL); Liran Liss, Atzmon-Segev (IL); Eliav Bar-Ilan, Or Akiva (IL); Aviad Yehezkel, Yokneam Ilit (IL); Omri Kahalan, Sylvan Lake (CA); Gal Shalom, Givat-Avni (IL)

(21) Appl. No.: 19/184,721

(22) Filed: Apr. 21, 2025

(51) Int. Cl. G06F 9/455

(52) U.S. Cl. CPC G06F 9/45558; G06F 2009/4557

(57) ABSTRACT

Approaches in accordance with various illustrative embodiments provide for the synchronized migration of virtual resources that use a limited network for at least certain communications. Virtual resources might be hosted on a first set of physical resources in a datacenter that are connected to a primary datacenter network, as well as a limited network that is only available to certain resources. If one of these virtual resources is to be migrated to a physical resource outside this limited network, and that virtual resource requires communication with other virtual resources over a limited network, then a determination can be made to perform a synchronized migration of those virtual resources together to another set of physical resources that are connected to a similar limited network, allowing the virtual resources to continue to use limited network communications that may have beneficial properties over use of a primary datacenter network.

### TECHNICAL FIELD

This disclosure relates generally to the management of computing resources, and in at least one embodiment relates to the synchronized live migration of computing resources in a complex computing environment, such as a datacenter.

### BACKGROUND

As compute jobs continue to increase in size and complexity, the complexity of the computing systems needed to perform these jobs is increasing as well. In many instances, a number of computing resources (e.g., physical or virtual compute resources) may be used together in a distributed manner to perform various portions of such a job. These resources may include a number of virtual machines (VMs), for example, that are hosted on physical resources and may communicate via multiple communication channels during performance of a job. While some of these channels, such as conventional networks that may connect to all physical compute resources in a datacenter, may allow for relatively straightforward migration, there may be one or more hardware-based data channels that are physically connected to only a specific group of hardware resources, used to host a group of VMs, which cannot quickly and easily be “live” migrated (during performance of a job) to one or more additional (or alternative) physical machines. As a result, moving a single VM that uses a graphics processing unit (GPU) in a given limited network domain can result in a disconnection from the other VMs in that limited network domain. Further, when migrating a VM that is communicating with other VMs in the network, the connection might fail due to a timeout if the VM does not resume within a specific period of time. Pausing different VMs at different times to perform migration operations can also introduce jitter that can result in communications being out of sync.

### BRIEF DESCRIPTION OF THE DRAWINGS

Various embodiments in accordance with the present disclosure will be described with reference to the drawings, in which:

FIG. 1A illustrates an example datacenter system architecture in which aspects of various embodiments can be implemented, according to at least one embodiment.

FIG. 1B illustrates an example layout of components in a datacenter, according to at least one embodiment.

FIG. 2A illustrates an example migration of a virtual machine in a datacenter, according to at least one embodiment.

FIG. 2B illustrates an example synchronized migration of virtual machines in a datacenter, according to at least one embodiment.

FIG. 3 illustrates an example process to determine to synchronously migrate a group of virtual resources, according to at least one embodiment.

FIG. 4 illustrates an example process to synchronously migrate a group of virtual resources, according to at least one embodiment.

FIG. 5 illustrates an example datacenter system, according to at least one embodiment.

FIG. 6 is a block diagram illustrating a computer system, according to at least one embodiment.

FIG. 7 is a block diagram illustrating a computer system, according to at least one embodiment.

FIG. 8 illustrates components of an example computing system, according to at least one embodiment.

FIG. 9 illustrates components of a system including multiple processing units connected by network switches, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various illustrative embodiments provide for “live” migration of virtual computing resources, such as virtual machines (VMs), between physical resources, such as servers in a datacenter. During processing of one or more compute jobs, it might be determined that an identified virtual machine (VM) is to be migrated. Such migration may not be straightforward, however, as the identified VM may communicate with other VMs over not only a datacenter-wide network (such as may use Ethernet or Infiniband connections) as a primary communication channel, but also a “limited” network that includes physical connections to only a subset of resources, such as a select group of servers, which can be used as a secondary communication channel. Such a limited network may use one or more high speed links with the ability to use atomic structures and variables and a unified memory map interface, such as NVLinks from NVIDIA Corporation, which can specifically allow for incredibly fast communication between a combination of, for example, switch devices and GPUs. The other VMs with which the VM is to be migrated can be identified, as part of a communication group, such that the VMs can be synchronously migrated together to one or more physical resources that also share a (separate) limited network. Such group migration allows the VMs to continue to use a shared (albeit different) secondary data channel available through a limited network without having to reconfigure the communication hardware. The VMs can be migrated transparently, using the datacenter-wide network, without any communication connections being broken that would otherwise result from the VMs being connected to separate limited networks. For a migration, the VMs in a group can be identified and data from those VMs pre-copied, at least to the extent possible or practical, in order to reduce the actual migration time once initiated. A first synchronization can be performed so that the pausing and migration of all VMs of a group occurs at substantially the same time. After migration, the VMs of the group can again be synchronized across all the physical hosts before operation is resumed. All VMs in a given limited network (e.g., NVLink) domain can be migrated together to a new limited network domain so communications can continue uninterrupted. Connections can be reestablished automatically for the group, such as by a migration service updating all relevant network addresses.

Variations of this and other such functionality can be used as well within the scope of the various embodiments as would be apparent to one of ordinary skill in the art in light of the teachings and suggestions contained herein.

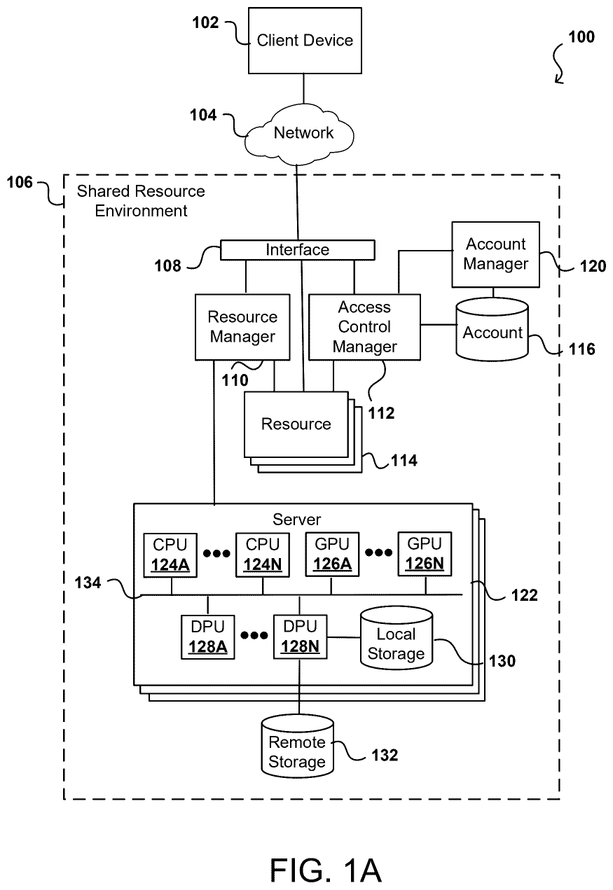

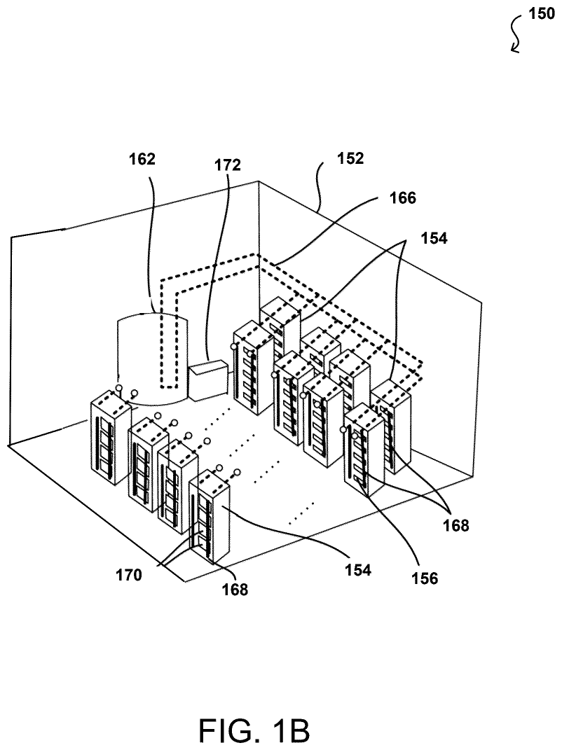

Environments such as datacenters can be used to perform various computing operations on behalf of a number of different entities, such as by using a pool of available resource capacity. FIG. 1A illustrates an example of one such architecture 100 that can be used in accordance with at least one embodiment. In this example, a user is able to use a client device 102 to submit one or more requests to access one or more resources, or to perform a task using one or more resources, among other such options. Such a request can be submitted over at least one network 104, such as the Internet or a cellular network, and received to an interface, address, or endpoint in a shared resource environment 106. The request can be received to an interface, such as an application programming interface (API) of an interface layer 108, for example, which may include other networking devices as well, as may include routers, network switches (e.g., an NV-Switch or Spectrum-X switch), load balancers, and the like. In this example, a request from a client device 102 may first need to be analyzed to determine whether the client device, user, or other entity associated with the request has access to one or more resources to be used to process the request, as well as to determine whether the type of access permitted allows for performance of the requested operation.

In this example, information for the request can be directed to an access control manager 112, or other such component, system, or service. The access control manager 112 can perform various tasks to determine and/or manage access to a set of shared resources 114, such as to extract relevant information from a received request and compare, by an account manager 120 or other such system or service, information for the request against information in an account repository 116 or other such location. If it is determined that the request is associated with a valid account, that account information can be used to determine the type of access permissible to perform one or more operations associated with the request. In some embodiments, an access control manager 112 may work with a resource manager 110 to determine a specific instance of a type of resource 114 to be used to perform an operation with respect to the request, whereas the resource manager 110 can perform other types of operations as needed, such as to allocate additional capacity of a type of resource, launch a new compute instance, or perform another such task associated with the request.

In many instances, a request that involves a number of operations to be performed may have those operations, or portions of those operations, distributed across a set of processing resources. This may include distribution across a number of physical compute resources, such as a set of shared servers, and/or may include multiple processing resources (physical or virtual) within a given physical resource. As an example, FIG. 1A illustrates example components that may be found within a given server 122 that may be allocated to perform one or more processing tasks with respect to a request. The server 122, in this instance, is illustrated to contain different types of processing units, including one or more central processing units (CPUs) 124A-124N, one or more graphics processing units (GPUs) 126A-126N, and one or more data processing units (DPUs) 128A-128N, as may be interconnected using at least one internal bus 134. At least the DPUs 128A-128N in this example may be connected to local storage 130 in the server, as well as at least one remote storage instance 132 that may be external to the server but within the shared resource environment 106. CPUs 124A-124N are often used for tasks such as single threaded user applications, and GPUs 126A-126N are often used to perform multiple small but related operations in parallel. DPUs can be used to offload processing tasks from these CPUs and GPUs that may not optimally be performed on these processing units, as may related to heterogeneous data-centric processing tasks that can benefit from a different type of accelerated processing. A DPU is a programmable processor or system-on-chip, which combines one or more multi-core, high-performance CPUs, a set of acceleration engines that can offload and improve performance for data-centric tasks, and one or more high-performance interfaces capable of parsing, processing, and efficiently transferring data at high speeds. A DPU can be used as a stand-alone embedded processor, or can be incorporated into a smart network interface card (SmartNIC) in a server, among other such options.

In at least one embodiment, a datacenter 150 in FIG. 1B may include one or more rooms 152 having racks 154 and auxiliary equipment to house one or more servers 170 on one or more server trays, as well as graphics processing units (GPUs) 156 and other such components. In at least one embodiment, a datacenter 150 can be supported by a cooling tower located external to the datacenter 150. A cooling tower can dissipate heat from within a datacenter 150 by acting on a primary cooling loop 166. In at least one embodiment, a cooling distribution unit (CDU) 162 is used between a primary cooling loop 166 and a secondary cooling loop, or other such heat removal mechanism. There may be cooling manifolds 168 used for individual server racks, for example, and a heat exchanger 172 or other temperature management system used to provide additional cooling and/or temperature management. Proper maintenance of such a datacenter involves not only maintenance of the computing resources, but also components and systems related to networking, power, cooling, and other such aspects. In many instances, maintenance of any one of these types of devices or systems may involve modification, at least temporarily, of one or more of these other types of devices or systems.

A manager of a datacenter, or a cloud service provider, might provide physical resources that are able to execute various concurrent computing jobs using various combinations and subsets of these resources. As part of the management and maintenance of such a complex computing environment, it will often be necessary to take a physical resource offline or otherwise make a resource at least temporarily unavailable in order to perform maintenance or updates, or perform other such operations. In many instances, there will be one or more compute jobs executing on a server or other compute resource that is to be taken offline. In order to avoid having to start those jobs over on another resource, or wait until the current physical resource is again available or replaced, for example, a datacenter manager may perform a migration of the processing jobs executing on that resource, along with any virtual resources (e.g., virtual machines VMs) that are executing those jobs. In many instances, a user will be unaware of the hardware being used to perform a compute job, such that the user will not care if the job is migrated to another resource, and also may not be aware of the migration. As long as the migration is performed without significant delay or increase in latency, the migration may be performed in a seamless manner without a user being able to even determine that a migration occurred.

When performing such a migration in many instances, it will be necessary (or at least advantageous) to use the same type of hardware for a given job or virtual resource before, and after, the migration. For example, if a VM is running on a first server that has a network interface card (NIC) and a graphics processing unit (GPU) configured in a certain way to support specific operations or communications, it can be advantageous to migrate the VM to a second server that includes a similar NIC and GPU with similar configurations, in order to avoid the need for reconfiguration or modification, as well as to ensure that the VM operates properly on the new server, among other such advantages. Processes such as pass-through device migration can be used to, for example, migrate a VM that is using a pass-through device, such as a NIC, from one physical server to another while maintaining active connectivity. A migration manager can manage various aspects of the migration, such as to perform reconnection and resumption after migration of the VM. After migration and resumption, the VM should be able to continue working in the same way on the new server as on the prior server. In many instances, the servers in a datacenter will all be connected to a datacenter-wide network as may be provided using a set of Ethernet cables and switches.

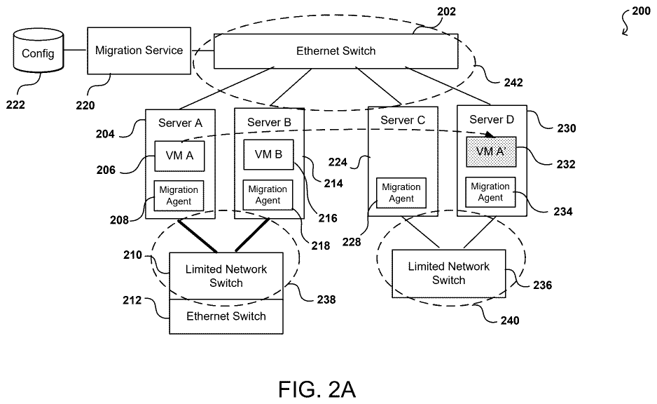

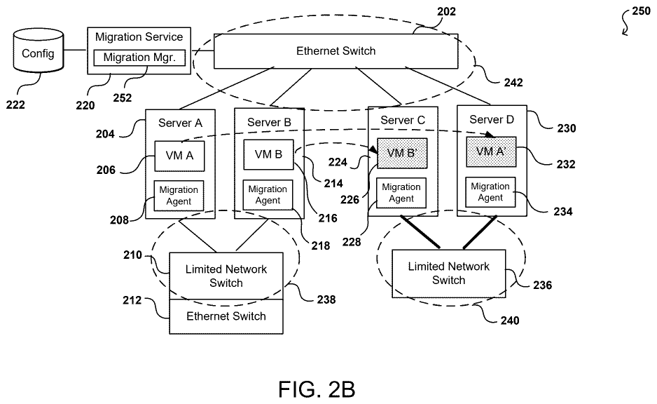

Difficulties can arise, however, when there are multiple smaller or “limited” networks in a complex computing environment such as a datacenter, and only a subset of resources is connected to each of these limited networks. FIG. 2A illustrates a view of an example system 200 that can operate in a complex computing environment, such as a datacenter, in accordance with various embodiments. It should be understood that such an environment can include various other resources and components (e.g., routers and load balancers, server racks, and other components such as those discussed with respect to FIGS. 1A and 1B) not illustrated in FIG. 2A, and that a selection of components was chosen for ease of explanation. In this example, there are four servers 204, 214, 224, 230 that are able to perform processing jobs as part of the complex computing environment. These can include independent jobs, or respective portions of a distributed compute job, among other such options. In this example, each server can be able to communicate with every other server using network connections for a primary network 242 of the computing environment, such as an Ethernet network provided using various Ethernet connections and at least one Ethernet switch 202. As mentioned, there may also be other networks provided in such an environment that may only be available for subsets of resources. Such “limited” networks may be provided where, for example, it may be desirable or beneficial to use a different type of communication link or protocol that has different properties-such as by providing higher speeds, tighter security, or more controllability, among other such options. For resources that benefit from such a network, the limited network can be physically connected to those specific resources. To minimize added complexity and cost, as well as to improve security, among other such benefits, such a network may be limited to a specific group of resources. The size and selection of resources in such a group may depend at least in part upon the types of jobs to be run on those resources that will utilize a secondary data channel provided by the limited network.

In this example, two of the servers—server A 204 and server B 214—are connected not only using the primary datacenter-wide (Ethernet-based) network 242, but are also connected via a limited network 238. The limited network 238 is illustrated to include physical connections between the two servers 204, 214 and a limited network switch 210, although additional network components may be included as well in various embodiments. The limited network switch can support a communication protocol such as NVLink, with the connections between the switch and the servers being NVLink-based connections. Other high speed interconnect standards can be used as well, as may be performed using Compute Express Link (CXL) or other such technology. As mentioned, protocols such as NVLink allow for the providing of speed links with the ability to use atomic structures and variables and a unified memory map interface, for example, which can allow for fast communication between connected components. As mentioned, such a limited network will have physical connections to only a limited set of resources, such that other resources will be unable to communicate over that specific limited network 238. Virtual resources such as VMs 206, 216 executing on those two servers 206, 214 can then communicate with each other using the primary datacenter network or the limited network, depending in part on the need, purpose, or type of communication, and can communicate with other servers 224, 230 not connected to the limited network 238 using the primary datacenter-based network 242. The network used may depend upon specific aspects or instructions associated with specific jobs, or portions of those jobs, as well as the networks available to a given VM. In some embodiments, a limited network switch 210 may also be able to communicate with an ethernet switch 212 or other communication domain, but can allow the connected servers to communicate using the limited network communication links.

During (or before) processing of a job, there may be an issue detected with at least one of the physical resources hosting one or more virtual machines that might cause a migration service 220 to initiate a migration. Such an issue may include, for example, an error detected with the hosting server, a need to update or modify the hosting server, or a determination of insufficient capacity of the hosting server, among other such options. In this example, a migration service 220 may determine (as may be based on monitored information, or a notification from a resource manager or other such component or service, etc.) that VM A 206 needs to be, or would at least benefit from being, migrated from server A. A migration service 220 can determine, based upon information from a configuration repository or one or more migration agents 208, 218, for example, that server A 204 is part of a group of servers that also includes server B 214, and which allows for communications between those servers using both a primary datacenter network 242 and a limited network 238 (or domain). In some embodiments, the migration service 220 might also, or alternatively, determine that the specific VM A 206 to be migrated communicates with at least VM B 216 using the limited network 238. It may also be determined that both VM A 206 and VM B 216 are processing portions of the same distributed processing job, or otherwise related jobs that may require communication using the limited network 238.

In such a situation, the migration service 220 can determine that it would not be sufficient to migrate VM A 206 to another server (such as server C 224 or server D 230) that is outside the domain of (or otherwise not connected to) the current limited network 238. As illustrated, if VM A 206 on server A 204 were to be migrated to a new VM A′ 232 on server D 230, then new VM A′ 232 would be unable to communicate with VM B 216 using the prior limited network 238, as server D 230 is not physically connected to the prior limited network 238. As such, any connection between VM A 206 and VM B 216 that used the prior limited network 238 would be broken under such a migration. Prior approaches to migrating a single VM thus will not be successful in such a situation.

As illustrated in the example state 250 of FIG. 2B, where reference numbers are carried over for similar components for simplicity of explanation, server D 230 is part of a group of resources that is connected to a second limited network 240 that includes servers 224, 230 connected using limited network connections and a second limited network switch 236. In this example, the second limited network 240 would use the same protocol (e.g., NVLink) and configuration as the first limited network 238, such that VMs on either limited network 238, 240 can communicate in the same way with other VMs on the same limited network or domain.

In order to allow VM A 206 and VM B 216 to be able to communicate using the same limited network without breaking connection upon migration of VM A 206 to server D 230, VM B 216 can be migrated together with VM A 206, and the migration of the two VMs can be to a server (or other physical resource) in the group of resources connected to the second limited network 240. If VM A 206 is migrated to server D 230 (as VM A′ 232), then VM B can be migrated to server D 230 as well, or can be migrated to server C 224 (as VM B′ 226) or any other server connected to the second limited network 240. By migrating both VMs to resources in a limited network group, the VMs can continue to communicate using limited network communications.

As illustrated in FIG. 2B, VM B 216 was migrated to a new VM B′ 226 on server C 224, which is in the same server group as server D 230 that shares the same limited network connections as part of the same limited network domain. After the migration, VM A′ 232 and VM B′ 226 can continue the respective processing jobs, or respective portions of the same processing job, using the hardware-based, limited network 240 associated with the new group of servers 224, 230. Whenever a VM or other virtual resource is to be migrated to a different limited network, any other VMs or virtual resources that require being on the same limited network can then also be migrated to a same subset or group of compute resources connected to a limited network, to avoid breaking connections between VMs processing parts of the same distributed computing job. In at least one embodiment, such a migration may be performed with minimal delay such that a user or application may be unable to determine that a migration occurred.

In at least one embodiment, a migration manager 252 (which may be part of a migration service 220) can be tasked with initiating, synchronizing, and ensuring accurate completion of the migration of multiple VMs as a group. The migration manager can have information indicating the current topology and configuration 222 of a given datacenter, for example, and can use this information to plan and coordinate the migration process. The individual migration agents 208, 218, 228, 234 on the respective servers or hosts can handle tasks such as the pre-migration copying of data to the new hosts, as well as the pausing and unpausing of processing by the respective VMs. Correct timing of the pause and unpause tasks can help to ensure accurate synchronization across the various VMs. In at least one embodiment, there can be at least two primary synchronization points. A first synchronization point that coincides with a pause of a VM to transfer data, to help ensure minimal disruption in processing. A second key synchronization point can coincide with a resuming of individual VMs on the destination servers or hosts, which can help to ensure that all the VMs are synchronized, which can help to maintain the integrity and continuity of the VM connections during the migration process.

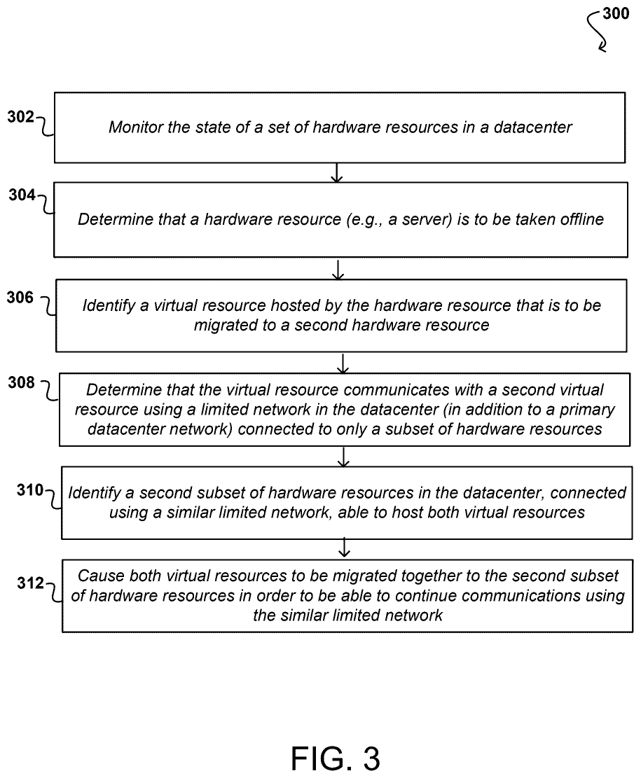

FIG. 3 illustrates an example process 300 that can be performed to allow for the identification and migration of a group of virtual resources communicating using a limited network, according to at least one embodiment. It should be understood that for this and other processes presented herein that there may be additional, fewer, or alternative steps performed or similar or alternative orders, or at least partially in parallel, within the scope of the various embodiments unless otherwise specifically stated. Further, although this example is described with respect to a limited network, various other types of limited resources, communications, or configurations may be used to determine whether to migrate a set of virtual resources to a specific group of hardware resources as well within the scope of the various embodiments. In this example, the state of a set of hardware resources in a datacenter can be monitored 302. Such monitoring may be performed by a resource manager, administrative service, or other such system, service, or component. It can be determined 304 that, due to an issue such as an error or need for an update, a given hardware resource (such as a compute server) is to be taken offline, at least temporarily. A virtual resource, such as a virtual machine, can be identified 306 that is hosted by the hardware resource, and that will need to be migrated to be hosted by a second hardware resource. This may be a virtual resource that is currently hosted by the hardware resource and may be actively performing a compute job, or may be part of a group of VMs that work together to perform aspects of a distributed compute job, among other such options.

The virtual resource (or physical resource hosting the virtual resource) can be analyzed to determine whether the virtual resource communities with any other virtual resources in the datacenter and, if so, which resources host the other virtual resource(s) and which networks (or domains, etc.) are used for communication among those virtual resources. In this example, it can be determined 308 that the virtual resource communicates with a second virtual resource using a limited network (e.g., an NVLink network) in the datacenter, as may be in addition to use of a primary datacenter network such as an Ethernet-based network, that is physically connected or otherwise available to only a subset of hardware resources in the datacenter. If the virtual resource is able to be migrated to another physical resource connected to the same limited network, then the virtual resource can be migrated by itself, and any appropriate remapping performed. It may be determined, however, that the migration will need to be to a physical resource that is not connected to the current limited network. In such a situation, it can be determined that the virtual resources need to be migrated together in order to allow these virtual resources to continue to communicate using limited network connections. A migration service, or other such system or service, can identify 310 a second subset of hardware resources in the datacenter that is connected using a similar limited network, and that has capacity to host both virtual resources. This may also include identifying other similar resources, configuration, software, or other such aspects as well. Once identified, both virtual resources can be caused 312 to be migrated together to the second subset of hardware resources, in order to allow the virtual resources to continue communications using a similar limited network.

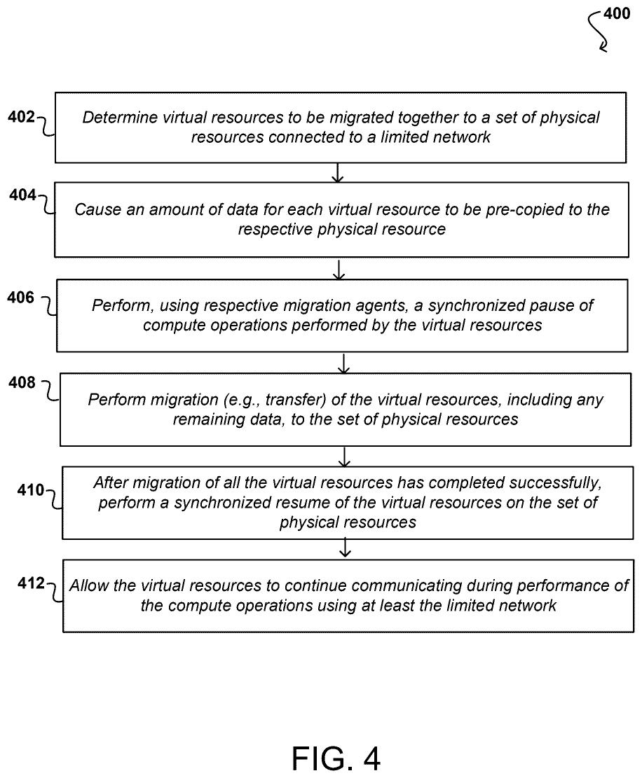

FIG. 4 illustrates another example process 400 that can be performed to allow for such synchronized migration of virtual resources according to at least one embodiment. In this example process, a determination is made 402 that at least two virtual resources are to be migrated together to a set of physical resources connected to a limited network. As discussed with respect to the process 300 of FIG. 3, this might be due at least in part to at least one of the virtual resources being determined to be migrated, and a migration manager (knowing the network topology, location of virtual resources, and connections among the virtual resources) determining that a group of virtual resources should be migrated together in order to allow those resources to continue to communicate using a limited network. As mentioned, each limited network will typically only be available to a specific subset of resources, and migrating only a single virtual resource to a physical resource that is not in that specific subset would cause the virtual resources to be connected to different limited networks and any connections between them broken. As mentioned, the physical resources may all be connected to a primary communications network for a datacenter or other such complex computing environment, but certain communications may benefit from, if not require, certain types of network connections that may allow for higher speeds, controllability, and/or security, among other such aspects. A migration manager that determines the virtual resources are to be migrated together can, based in part on the network topology, identify a new group of hardware resources that have capacity to host the virtual resources and that are also connected by a similar limited network or other such domain.

In at least one embodiment, a migration manager can contact a migration agent on each physical resource to initiate migration of each respective virtual resource. This can include identifying data that can be transmitted (or copied over) to the new hosting physical resource before an actual migration occurs, as part of a pre-copy operation, and causing 404 an amount of data for each virtual resource to be pre-copied to the respective physical resource. The data may be pre-copied over the primary datacenter network. The virtual resources can continue to process the current job while data is being pre-copied to the new destination host. Each migration agent can track any changes that occur during the pre-copy stage to ensure data consistency, such that each virtual resource after the migration will have an accurate set of data based on the most recent operations. The pre-copying of data can help to reduce the amount of time needed to perform the actual migration of the virtual resources, which can help to improve efficiency and reduce latency for these operations. In at least one embodiment, data can be pre-copied until at least one threshold or criterion is at least met or satisfied, such as a minimum amount of data transfer, a maximum amount of transfer time, a target amount of data iterations, or another such metric. Any changes that occur during a pre-copying stage and are also able to be pre-copied can be pre-copied to the new host as well. A benefit of a pre-copy stage is that it can help to keep the time duration of the pause state to a minimum, as most of the data has already been copied over to the new host. If a given virtual resource does not write data to memory as part of an operation, then all the data for that virtual resource may be able to be pre-copied. In some embodiments, processor throttling may be applied during a pre-copy stage to reduce the amount of data to be transferred in the migration state, or at least to minimize the volume of updates to be transferred during a pre-copy stage.

The respective migration agents on each physical resource can communicate with the migration manager over the primary datacenter network, and can work together to perform 406 (or cause to be performed) a synchronized pause of the compute operations performed by the virtual resources. Each virtual resource may take a different amount of time to reach the target threshold or criterion, and it can be important to perform migration at substantially the same time in order to avoid inconsistencies in data, broken communications, or other such undesired results. In at least one embodiment, a synchronized pause can be performed once all virtual resources have satisfied a given threshold or criterion, or may be performed once any of the virtual resources has satisfied a given threshold or criterion, among other such options. A migration manager or service can then perform 408 (or cause to be performed) a migration (or transfer) of the (paused) virtual resources, including any data that was not already pre-copied or has been updated since pre-copying of at least a portion of the data. Migration can include tasks such as copying of data, instantiating a new virtual resource on the target host machine, performing configuration and reconnections, and the like. A migration manager can verify that the migration has completed for each virtual resource, and that the appropriate reconnections and reconfiguration have been addressed such that the virtual resource can resume operation without need to perform any reconfiguration or updating, other than potentially an updating of addresses or other such aspects due to the different hosts or limited network. An example migration process, as may be directed by the migration manager, can include verifying the presence of a limited network connection for all virtual resources of the group being migrated, as well as handling respective connections to other physical and virtual resources, such as NICs, physical or virtual GPUs, and other such components. At an appropriate time after migration of all the virtual resources has completed successfully, the migration agents on the new hosting physical resources can perform 410 a synchronized resume of the virtual resources, and the virtual resources can be allowed 412 to resume processing of the current job(s) on the new hosts, and continue communicating during performance of these operations using at least the new, but similar, limited network. A synchronized resume also helps to ensure consistency, so that the virtual resources do not get out of sync or end up with broken connections, among other such potentially undesirable outcomes. Such an approach can allow for virtual resources to be migrated without having to change the topology of the physical network. In the event of a failure of a single virtual resource migration, that migration may be attempted again, to the same hardware resource or a different hardware resource of the same limited network domain. If a migration fails, the migration may be aborted, and if the information was maintained on the prior physical resources during migration, then those resources may resume hosting the virtual resources until another migration or operation can be performed.

A resume operation can perform various operations as may be necessary for continued processing, which may include creating virtual functions for various hardware devices. For example, a migration process might start up a virtual GPU instance to support a migrated VM on a given host. The virtual GPU may be automatically connected to the limited network as appropriate. A migration manager, which knows the network topology and configuration, can also be responsible for connecting the VM to the virtual GPU, as well as any necessary NICs, CPUs, DPUs, or other such components. A given hardware resource may have multiple NICs that communicate with multiple limited networks, and a migration manager can ensure that a given virtual resource is connected to the appropriate NICs and/or networks. Migration can also potentially be optimized for specific types of combinations of hardware or networks.

### Datacenter

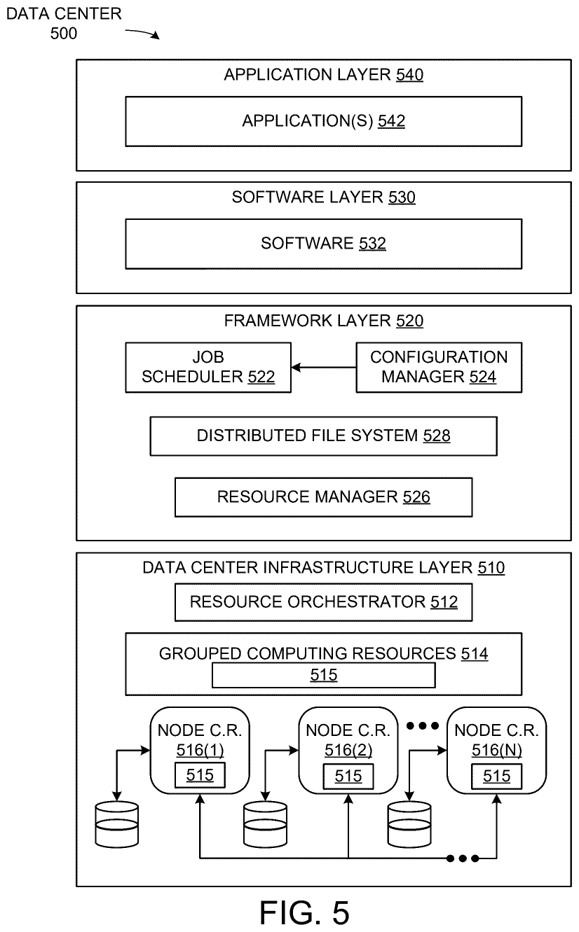

FIG. 5 illustrates the architecture of an example datacenter 500, in which at least one embodiment may be implemented. In at least one embodiment, data in this datacenter 500 includes a datacenter infrastructure layer 510, a framework layer 520, a software layer 530, and an application layer 540.

In at least one embodiment, as shown in FIG. 5, datacenter infrastructure layer 510 may include a resource orchestrator 512, grouped computing resources 514, and node computing resources (“node C.R.s”) 516(1)-516(N), where “N” represents a positive integer (which may be a different integer “N” than used in other figures). In at least one embodiment, node C.R.s 516(1)-516(N) may include, but are not limited to, any number of central processing units (“CPUs”) or other processors (including accelerators, field programmable gate arrays (FPGAs), graphics processors, etc.), memory storage devices 518(1)-518(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 516(1)-516(N) may be a server having one or more of above-mentioned computing resources.

In at least one embodiment, grouped computing resources 514 may include separate groupings of node C.R.s housed within one or more racks (not shown), or many racks housed in datacenters at various geographical locations (also not shown). In at least one embodiment, separate groupings of node C.R.s within grouped computing resources 514 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 512 may configure or otherwise control one or more node C.R.s 516(1)-516(N) and/or grouped computing resources 514. In at least one embodiment, resource orchestrator 512 may include a software design infrastructure (“SDI”) management entity for datacenter 500. In at least one embodiment, resource orchestrator 512 may include hardware, software or some combination thereof.

In at least one embodiment, as shown in FIG. 5, framework layer 520 includes a job scheduler 522, a configuration manager 524, a resource manager 526 and a distributed file system 528. In at least one embodiment, framework layer 520 may include a framework to support software 532 of software layer 530 and/or one or more application(s) 542 of application layer 540. In at least one embodiment, software 532 or application(s) 542 may respectively include web-based service software or applications, such as those provided by Amazon Web Services, Google Cloud and Microsoft Azure. In at least one embodiment, framework layer 520 may be, but is not limited to, a type of free and open-source software web application framework such as Apache Spark™ (hereinafter “Spark”) that may utilize distributed file system 528 for large-scale data processing (e.g., “big data”). In at least one embodiment, job scheduler 522 may include a Spark driver to facilitate scheduling of workloads supported by various layers of datacenter 500. In at least one embodiment, configuration manager 524 may be capable of configuring different layers such as software layer 530 and framework layer 520 including Spark and distributed file system 528 for supporting large-scale data processing. In at least one embodiment, resource manager 526 may be capable of managing clustered or grouped computing resources mapped to or allocated for support of distributed file system 528 and job scheduler 522. In at least one embodiment, clustered or grouped computing resources may include grouped computing resources 514 at datacenter infrastructure layer 510. In at least one embodiment, resource manager 526 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 528 of framework layer 520. In at least one embodiment, one or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 528 of framework layer 520. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 524, resource manager 526, and resource orchestrator 512 may implement any number and type of self-modifying actions based on any amount and type of data acquired in any technically feasible fashion. In at least one embodiment, self-modifying actions may relieve a datacenter operator of datacenter 500 from making possibly bad configuration decisions and possibly avoiding underutilized and/or poor performing portions of a datacenter.

In at least one embodiment, datacenter 500 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 500. In at least one embodiment, trained machine learning models corresponding to one or more neural networks may be used to infer or predict information using resources described above with respect to datacenter 500 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 5 for inferencing or predicting operations based, at least in part, on weight parameters calculated using neural network training operations, neural network functions and/or architectures, or neural network use cases described herein.

Embodiments presented herein can allow for synchronized migration of virtual resources that require access to a limited network or other resource(s) with limited accessibility.

### Computer Systems

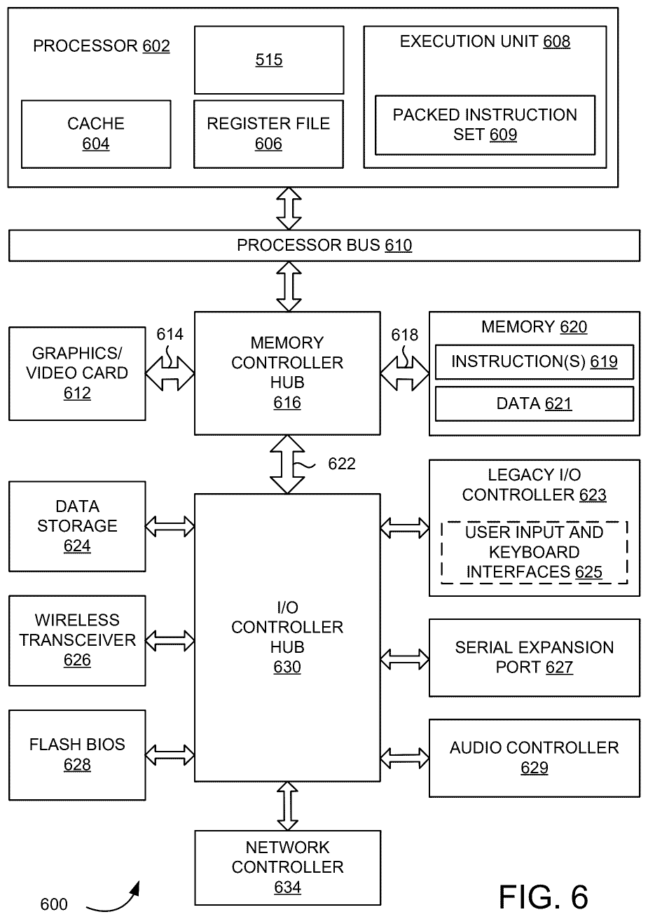

FIG. 6 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 600 may include, without limitation, a component, such as a processor 602 to employ execution units including logic to perform algorithms for process data, in accordance with present disclosure, such as in embodiment described herein. In at least one embodiment, computer system 600 may include processors, such as PENTIUM® Processor family, Xeon™, Itanium®, Scale™ and/or StrongARM™, Intel® Core™, or Intel® Nirvana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“Necks”), set-top boxes, network hubs, wide area network (“WAN”) switches, or any other system that may perform one or more instructions in accordance with at least one embodiment.

In at least one embodiment, computer system 600 may include, without limitation, processor 602 that may include, without limitation, one or more execution units 608 to perform machine learning model training and/or inferencing according to techniques described herein. In at least one embodiment, computer system 600 is a single processor desktop or server system, but in another embodiment, computer system 600 may be a multiprocessor system. In at least one embodiment, processor 602 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“L1”) internal cache memory (“cache”) 604. In at least one embodiment, processor 602 may have a single internal cache or multiple levels of internal cache. In at least one embodiment, cache memory may reside external to processor 602. Other embodiments may also include a combination of both internal and external caches depending on particular implementation and needs. In at least one embodiment, a register file 606 may store different types of data in various registers including, without limitation, integer registers, floating point registers, status registers, and an instruction pointer register.

In at least one embodiment, execution unit 608, including, without limitation, logic to perform integer and floating point operations, also resides in processor 602. In at least one embodiment, processor 602 may also include a microcode (“code”) read only memory (“ROM”) that stores microcode for certain macro instructions. In at least one embodiment, execution unit 608 may include logic to handle a packed instruction set 609. In at least one embodiment, by including packed instruction set 609 in an instruction set of a general-purpose processor, along with associated circuitry to execute instructions, operations used by many multimedia applications may be performed using packed data in processor 602. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 608 may also be used in microcontrollers, embedded processors, graphics devices, DSPs, and other types of logic circuits. In at least one embodiment, computer system 600 may include, without limitation, a memory 620. In at least one embodiment, memory 620 may be a Dynamic Random Access Memory (“DRAM”) device, a Static Random Access Memory (“SRAM”) device, a flash memory device, or another memory device. In at least one embodiment, memory 620 may store instruction(s) 619 and/or data 621 represented by data signals that may be executed by processor 602.

In at least one embodiment, a system logic chip may be coupled to processor bus 610 and memory 620. In at least one embodiment, a system logic chip may include, without limitation, a memory controller hub (“MCH”) 616, and processor 602 may communicate with MCH 616 via processor bus 610. In at least one embodiment, MCH 616 may provide a high bandwidth memory path 618 to memory 620 for instruction and data storage and for storage of graphics commands, data, and textures. In at least one embodiment, MCH 616 may direct data signals between processor 602, memory 620, and other components in computer system 600 and to bridge data signals between processor bus 610, memory 620, and a system I/O interface 622. In at least one embodiment, a system logic chip may provide a graphics port for coupling to a graphics controller. In at least one embodiment, MCH 616 may be coupled to memory 620 through high bandwidth memory path 618 and a graphics/video card 612 may be coupled to MCH 616 through an Accelerated Graphics Port (“AGP”) interconnect 614.

In at least one embodiment, computer system 600 may use system I/O interface 622 as a proprietary hub interface bus to couple MCH 616 to an I/O controller hub (“ICH”) 630. In at least one embodiment, ICH 630 may provide direct connections to some I/O devices via a local I/O bus. In at least one embodiment, a local I/O bus may include, without limitation, a high speed I/O bus for connecting peripherals to memory 620, a chipset, and processor 602. Examples may include, without limitation, an audio controller 629, a firmware hub (“flash BIOS”) 628, a wireless transceiver 626, a data storage 624, a legacy I/O controller 623 containing user input and keyboard interfaces 625, a serial expansion port 627, such as a Universal Serial Bus (“USB”) port, and a network controller 634. In at least one embodiment, data storage 624 may comprise a hard disk drive, a floppy disk drive, a CD-ROM device, a flash memory device, or other mass storage device.

In at least one embodiment, FIG. 6 illustrates a system, which includes interconnected hardware devices or “chips”, whereas in other embodiments, FIG. 6 may illustrate an exemplary SoC In at least one embodiment, devices illustrated in FIG. 6 may be interconnected with proprietary interconnects, standardized interconnects (e.g., PCIe) or some combination thereof. In at least one embodiment, one or more components of computer system 600 are interconnected using compute express link (CXL) interconnects.

Inference and/or training logic 515 are used to perform inferencing and/or training operations associated with one or more embodiments. In at least one embodiment, inference and/or training logic 515 may be used in system FIG. 6 for inferencing or predicting operations based, at least in part, on weight parameters calculated using neural network training operations, neural network functions and/or architectures, or neural network use cases described herein.

Embodiments presented herein can allow for synchronized migration of virtual resources that require access to a limited network or other resource(s) with limited accessibility.

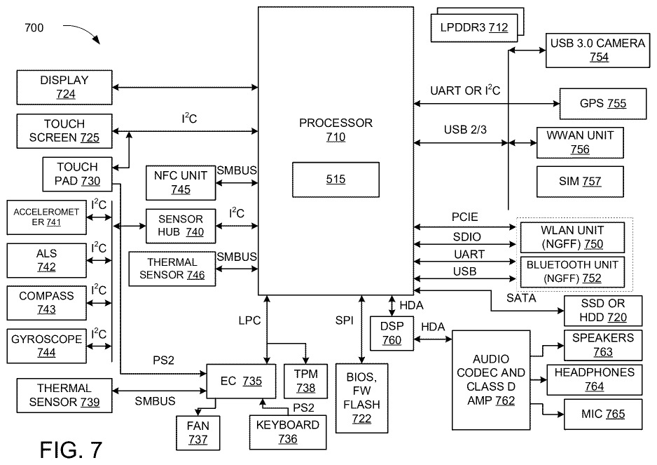

FIG. 7 is a block diagram illustrating an electronic device 700 for utilizing a processor 710, according to at least one embodiment. In at least one embodiment, electronic device 700 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 700 may include, without limitation, processor 710 communicatively coupled to any suitable number or kind of components, peripherals, modules, or devices. In at least one embodiment, processor 710 is coupled using a bus or interface, such as a I²C bus, a System Management Bus (“Sambas”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 7 illustrates a system, which includes interconnected hardware devices or “chips”, whereas in other embodiments, FIG. 7 may illustrate an exemplary SoC. In at least one embodiment, devices illustrated in FIG. 7 may be interconnected with proprietary interconnects, standardized interconnects (e.g., PCIe) or some combination thereof. In at least one embodiment, one or more components of FIG. 7 are interconnected using compute express link (CXL) interconnects.

In at least one embodiment, FIG. 7 may include a display 724, a touch screen 725, a touch pad 730, a Near Field Communications unit (“NFC”) 745, a sensor hub 740, a thermal sensor 746, an Express Chipset (“EC”) 735, a Trusted Platform Module (“TPM”) 738, BIOS/firmware/flash memory (“BIOS, FW Flash”) 722, a DSP 760, a drive 720 such as a Solid State Disk (“SSD”) or a Hard Disk Drive (“HDD”), a wireless local area network unit (“WLAN”) 750, a Bluetooth unit 752, a Wireless Wide Area Network unit (“WWAN”) 756, a Global Positioning System (GPS) unit 755, a camera (“USB 3.0 camera”) 754 such as a USB 3.0 camera, and/or a Low Power Double Data Rate (“LPDDR”) memory unit (“LPDDR3”) 715 implemented in, for example, an LPDDR3 standard. These components may each be implemented in any suitable manner.

In at least one embodiment, other components may be communicatively coupled to processor 710 through components described herein. In at least one embodiment, an accelerometer 741, an ambient light sensor (“ALS”) 742, a compass 743, and a gyroscope 744 may be communicatively coupled to sensor hub 740. In at least one embodiment, a thermal sensor 739, a fan 737, a keyboard 736, and touch pad 730 may be communicatively coupled to EC 735. In at least one embodiment, speakers 763, headphones 764, and a microphone (“mic”) 765 may be communicatively coupled to an audio unit (“audio codec and class D amp”) 762, which may in turn be communicatively coupled to DSP 760. In at least one embodiment, audio unit 762 may include, for example and without limitation, an audio coder/decoder (“codec”) and a class D amplifier. In at least one embodiment, a SIM card (“SIM”) 757 may be communicatively coupled to WWAN unit 756. In at least one embodiment, components such as WLAN unit 750 and Bluetooth unit 752, as well as WWAN unit 756 may be implemented in a Next Generation Form Factor (“NGFF”).

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

Embodiments presented herein can allow for synchronized migration of virtual resources that require access to a limited network or other resource(s) with limited accessibility.

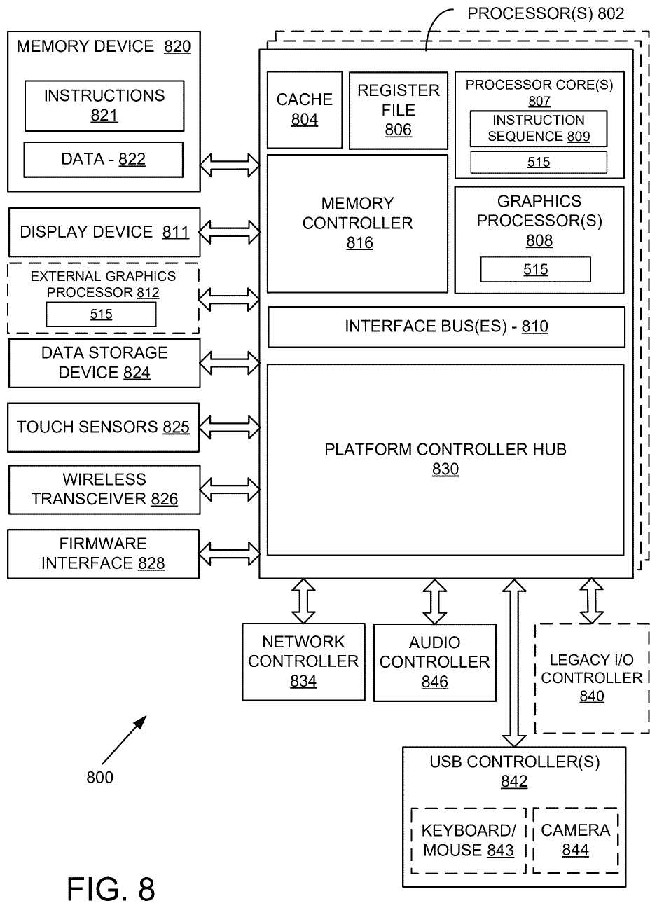

FIG. 8 is a block diagram of a processing system, according to at least one embodiment. In at least one embodiment, system 800 includes one or more processor(s) 802 and one or more graphics processor(s) 808, and may be a single processor desktop system, a multiprocessor workstation system, or a server system having a large number of processor(s) 802 or processor core(s) 807. In at least one embodiment, system 800 is a processing platform incorporated within a system-on-a-chip (SoC) integrated circuit for use in mobile, handheld, or embedded devices. In at least one embodiment, one or more graphics processor(s) 808 include one or more graphics cores.

In at least one embodiment, system 800 can include, or be incorporated within a server-based gaming platform, a game console, including a game and media console, a mobile gaming console, a handheld game console, or an online game console. In at least one embodiment, system 800 is a mobile phone, a smart phone, a tablet computing device or a mobile Internet device. In at least one embodiment, processing system 800 can also include, couple with, or be integrated within a wearable device, such as a smart watch wearable device, a smart eyewear device, an augmented reality device, or a virtual reality device. In at least one embodiment, processing system 800 is a television or set top box device having one or more processor(s) 802 and a graphical interface generated by one or more graphics processor(s) 808.

In at least one embodiment, one or more processor(s) 802 each include one or more processor core(s) 807 to process instructions which, when executed, perform operations for system and user software. In at least one embodiment, each of one or more processor core(s) 807 is configured to process a specific instruction sequence 809. In at least one embodiment, instruction sequence 809 may facilitate Complex Instruction Set Computing (CISC), Reduced Instruction Set Computing (RISC), or computing via a Very Long Instruction Word (VLIW). In at least one embodiment, processor core(s) 807 may each process a different instruction sequence 809, which may include instructions to facilitate emulation of other instruction sequences. In at least one embodiment, processor core(s) 807 may also include other processing devices, such a Digital Signal Processor (DSP).

In at least one embodiment, processor(s) 802 includes a cache memory 804. In at least one embodiment, processor(s) 802 can have a single internal cache or multiple levels of internal cache. In at least one embodiment, cache memory is shared among various components of processor(s) 802. In at least one embodiment, processor(s) 802 also uses an external cache (e.g., a Level-3 (L3) cache or Last Level Cache (LLC)) (not shown), which may be shared among processor core(s) 807 using known cache coherency techniques. In at least one embodiment, a register file 806 is additionally included in processor(s) 802, which may include different types of registers for storing different types of data (e.g., integer registers, floating point registers, status registers, and an instruction pointer register). In at least one embodiment, register file 806 may include general-purpose registers or other registers.

In at least one embodiment, one or more processor(s) 802 are coupled with one or more interface bus(es) 810 to transmit communication signals such as address, data, or control signals between processor(s) 802 and other components in system 800. In at least one embodiment, interface bus(es) 810 can be a processor bus, such as a version of a Direct Media Interface (DMI) bus. In at least one embodiment, interface bus(es) 810 is not limited to a DMI bus, and may include one or more Peripheral Component Interconnect buses (e.g., PCI, PCI Express), memory busses, or other types of interface busses. In at least one embodiment processor(s) 802 include an integrated memory controller 816 and a platform controller hub 830. In at least one embodiment, memory controller 816 facilitates communication between a memory device and other components of system 800, while platform controller hub (PCH) 830 provides connections to I/O devices via a local I/O bus.

In at least one embodiment, a memory device 820 can be a dynamic random access memory (DRAM) device, a static random access memory (SRAM) device, flash memory device, phase-change memory device, or some other memory device having suitable performance to serve as process memory. In at least one embodiment, memory device 820 can operate as system memory for system 800, to store data 822 and instructions 821 for use when one or more processor(s) 802 executes an application or process. In at least one embodiment, memory controller 816 also couples with an optional external graphics processor 812, which may communicate with one or more graphics processor(s) 808 in processor(s) 802 to perform graphics and media operations. In at least one embodiment, a display device 811 can connect to processor(s) 802. In at least one embodiment, display device 811 can include one or more of an internal display device, as in a mobile electronic device or a laptop device, or an external display device attached via a display interface (e.g., DisplayPort, etc.). In at least one embodiment, display device 811 can include a head mounted display (HMD) such as a stereoscopic display device for use in virtual reality (VR) applications or augmented reality (AR) applications.

In at least one embodiment, platform controller hub 830 enables peripherals to connect to memory device 820 and processor(s) 802 via a high speed I/O bus. In at least one embodiment, I/O peripherals include, but are not limited to, an audio controller 846, a network controller 834, a firmware interface 828, a wireless transceiver 826, touch sensors 825, a data storage device 824 (e.g., hard disk drive, flash memory, etc.). In at least one embodiment, data storage device 824 can connect via a storage interface (e.g., SATA) or via a peripheral bus, such as a Peripheral Component Interconnect bus (e.g., PCI, PCI Express). In at least one embodiment, touch sensors 825 can include touch screen sensors, pressure sensors, or fingerprint sensors. In at least one embodiment, wireless transceiver 826 can be a Wi-Fi transceiver, a Bluetooth transceiver, or a mobile network transceiver such as a 3G, 4G, or Long Term Evolution (LTE) transceiver. In at least one embodiment, firmware interface 828 enables communication with system firmware, and can be, for example, a unified extensible firmware interface (UEFI). In at least one embodiment, network controller 834 can enable a network connection to a wired network. In at least one embodiment, a high-performance network controller (not shown) couples with interface bus(es) 810. In at least one embodiment, audio controller 846 is a multi-channel high definition audio controller. In at least one embodiment, system 800 includes an optional legacy I/O controller 840 for coupling legacy (e.g., Personal System 2 (PS/2)) devices to system 800. In at least one embodiment, platform controller hub 830 can also connect to one or more Universal Serial Bus (USB) controller(s) 842 connect input devices, such as keyboard and mouse 843 combinations, a camera 844, or other USB input devices.

In at least one embodiment, an instance of memory controller 816 and platform controller hub 830 may be integrated into a discreet external graphics processor, such as external graphics processor 812. In at least one embodiment, platform controller hub 830 and/or memory controller 816 may be external to one or more processor(s) 802. For example, in at least one embodiment, system 800 can include an external memory controller 816 and platform controller hub 830, which may be configured as a memory controller hub and peripheral controller hub within a system chipset that is in communication with processor(s) 802.

Embodiments presented herein can allow for synchronized migration of virtual resources that require access to a limited network or other resource(s) with limited accessibility.

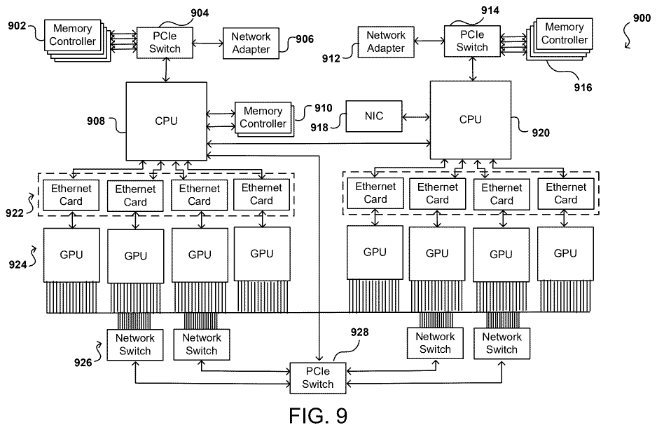

FIG. 9 illustrates an example enterprise AI system that can be used to perform at least AI-related tasks in accordance with at least one embodiment. An example of such a system is an H100 or H200 DGX system implementing the NVIDIA DGX™ platform from NVIDIA Corporation. The NVIDIA DGX™ H100/H200 Systems are built for all AI infrastructure and workloads from analytics to training to inference. The DGX H100/H200 systems are built on eight GPUs 924, such as NVIDIA H100 Tensor Core GPUs or eight NVIDIA H200 Tensor Core GPUs. Although not illustrated in FIG. 9, other types of processing units can be used as well, such as data processing units (DPUs). The illustrated system 900 includes a pair of CPUs 908, 920, such as Intel Xeon CPUs with 56 cores each. The CPUs 908, 920 are connected to the eight GPUs 924 using a set of Ethernet cards 922, such as ConnectX-7 Network Modules, which are connected in turn to a number of network switches 926, such as NVSwitches. The network switches 926 are connected to a PCIe switch 928, which can be connected back to at least one of the CPUs 908. A first CPU 908 can be connected directly to a memory controller 910, such as an NVMe controller, and to other memory controllers 902 indirectly through a PCIe switch 904, which can also connect the CPU 908 to a network adapter 906, such as a ConnectX-7 adapter. A second CPU 920 can be connected to the first CPU 908 as well as a network interface card (NIC) 918. The second CPU 920 can also be connected, through another PCIe switch 914, to a network adapter 912 and one or more memory controllers 916.

An example Nvidia DGX (Deep GPU Xceleration) implementation can include a number of servers and workstations that are geared towards enhancing deep learning applications through the use of general-purpose computing on graphics processing units (GPUs). Such systems may come in a rackmount format featuring high-performance x86 server CPUs on the motherboard. A core feature of an example DGX system is its inclusion of 8 or more NVIDIA GPU modules, which are housed on an independent system board. These GPUs can be connected either via a version of the SXM socket or a PCIe x16 slot, facilitating flexible integration within the system architecture. To manage the substantial thermal output, DGX units are equipped with heatsinks and fans designed to maintain optimal operating temperatures. This framework makes DGX units suitable for computational tasks associated with artificial intelligence and machine learning models. In one embodiment, the GPUs can be connected using an NVLink mesh network.

Embodiments presented herein can allow for synchronized migration of virtual resources that require access to a limited network or other resource(s) with limited accessibility.

Various embodiments can be described by the following clauses:
1. A system, comprising:
   one or more processing units to identify, for a migration of a first virtual computing resource in a datacenter, one or more second virtual computing resources that communicate with the first virtual computing resource through a first limited network, the one or more processing units to perform a synchronized migration of the first virtual computing resource and the one or more second virtual computing resources to one or more servers connected to a second limited network, similar in topology and configuration to the first limited network, allowing the first virtual computing resource and the one or more second virtual computing resources to continue communication after completion of the synchronized migration.
2. The system of clause 1, wherein the one or more processing units are further to:
   transfer a portion of data stored for at least the first virtual computing resource during a pre-copy phase; and
   transfer a remaining portion of the data stored for the first virtual computing resource during the synchronized migration.
3. The system of clause 2, wherein the one or more processing units are further to: pause processing jobs being performed by the first virtual computing resource and the one or more second virtual computing resources when the pre-copy phase satisfies at least one pause criterion for both the first virtual computing resource and the one or more second virtual resources; and
   transferring the processing jobs to, and resuming the processing jobs on, the one or more servers connected to the second limited network after the first virtual computing resource and the one or more second virtual computing resources are paused.
4. The system of clause 3, wherein the at least one pause criterion includes at least one of a minimum amount of data transfer, a maximum amount of transfer time, or a target amount of data iterations.
5. The system of clause 2, wherein the one or more processing units are further to: determine that migration has completed successfully for both the first virtual computing resource and the one or more second virtual computing resources to the one or more servers; and
   perform a synchronized resume of the first virtual computing resource and the one or more second virtual computing resources on the one or more servers.
6. The system of clause 2, wherein the one or more processing units are further to: automatically perform any remapping, reconfiguration, or reconnection of the first virtual computing resource and the one or more second virtual computing resources on the one or more servers as part of the synchronized migration.
7. The system of clause 1, wherein the first virtual computing resource and the one or more second virtual computing resources are further able to communicate using a datacenter-side communication network before, and after, the synchronized migration.
8. The system of clause 1, wherein the first limited network and the second limited network both use NVLink or Compute Express Link (CXL) communications.
9. At least one processor, comprising:
   one or more logical units to:
   determine, in response to a planned migration of a virtual machine, to migrate a group of virtual machines, able to communicate through a primary network and through a first limited network, to one or more servers able to communicate using the primary network and a second limited network, the second limited network being similar to the first limited network but connected to a different set of servers;
   perform, after copying a preliminary portion of data for the group of virtual machines to the one or more servers, a synchronized pause of the group of virtual machines;
   perform, after the synchronized pause, a transfer of the group of virtual machines to the one or more servers; and
   perform, after the transfer has completed, a synchronized resume of the group of virtual machines, the group of virtual machines being allowed to continue communication using the primary network and the second limited network.
10. The at least one processor of clause 9, wherein the one or more logical units are further to:
   use migration agents on individual servers to manage the copying of the preliminary portion of data, the synchronized pause, and the synchronized resume.
11. The at least one processor of clause 10, wherein the one or more logical units are further to:
   use a migration manager, able to communicate with the migration agents, to initiate the migration and determine successful completion of the migration.
12. The at least one processor of clause 9, wherein the first limited network and the second limited network both use NVLink or Compute Express Link (CXL) communications.
13. The at least one processor of clause 9, wherein the one or more logical units are further to:
   perform the synchronized pause after the copying of the preliminary portion of the data satisfies at least one pause criterion for all of the group of virtual machines.
14. The at least one processor of clause 13, wherein the at least one pause criterion includes at least one of a minimum amount of data transfer, a maximum amount of transfer time, or a target amount of data iterations.
15. The at least one processor of clause 9, wherein the one or more logical units are further to:
   allow processing jobs, being performed by the group of virtual machines before the migration, to continue being performed by the group of virtual machines after the migration.
16. The at least one processor of clause 9, wherein the one or more logical units are further to:
   automatically remap network addresses for the group of virtual machines after the migration.
17. A migration manager for a datacenter, comprising:
   one or more processing units to:
   determine, in response to a planned migration of at least one virtual machine, to migrate a group of virtual machines, able to communicate through a primary network and through a first limited network, to one or more servers able to communicate using the primary network and a second limited network, the second limited network being similar to the first limited network but connected to a different set of servers in the datacenter;
   perform, after a synchronized pause of the group of virtual machines, transfer of the group of virtual machines to the one or more servers; and
   perform, after the transfer has completed, a synchronized resume of the group of virtual machines, the group of virtual machines allowed to continue communication using the primary network and the second limited network.
18. The migration manager of clause 17, wherein the one or more processing units are further to:
   copy a preliminary portion of data for the group of virtual machines to the one or more servers before performing the synchronized pause of the group of virtual machines.
19. The migration manager of clause 18, wherein the one or more processing units are further to:
   pause processing jobs, being performed by the group of virtual machines, once copying of the preliminary portion of data satisfies at least one pause criterion for all virtual machines of the group, wherein the at least one pause criterion includes at least one of a minimum amount of data transfer, a maximum amount of transfer time, or a target amount of data iterations.
20. The migration manager of clause 17, wherein the first limited network and the second limited network both use NVLink or Compute Express Link (CXL) communications.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
one or more processing units to identify, for a migration of a first virtual computing resource in a datacenter, one or more second virtual computing resources that communicate with the first virtual computing resource through a first limited network, the one or more processing units to perform a synchronized migration of the first virtual computing resource and the one or more second virtual computing resources to one or more servers connected to a second limited network, similar in topology and configuration to the first limited network, allowing the first virtual computing resource and the one or more second virtual computing resources to continue communication after completion of the synchronized migration.

2. The system of claim 1, wherein the one or more processing units are further to:
transfer a portion of data stored for at least the first virtual computing resource during a pre-copy phase; and
transfer a remaining portion of the data stored for the first virtual computing resource during the synchronized migration.

3. The system of claim 2, wherein the one or more processing units are further to:
pause processing jobs being performed by the first virtual computing resource and the one or more second virtual computing resources when the pre-copy phase satisfies at least one pause criterion for both the first virtual computing resource and the one or more second virtual resources; and
transferring the processing jobs to, and resuming the processing jobs on, the one or more servers connected to the second limited network after the first virtual computing resource and the one or more second virtual computing resources are paused.

4. The system of claim 3, wherein the at least one pause criterion includes at least one of a minimum amount of data transfer, a maximum amount of transfer time, or a target amount of data iterations.

5. The system of claim 2, wherein the one or more processing units are further to:
determine that migration has completed successfully for both the first virtual computing resource and the one or more second virtual computing resources to the one or more servers; and
perform a synchronized resume of the first virtual computing resource and the one or more second virtual computing resources on the one or more servers.

6. The system of claim 2, wherein the one or more processing units are further to:
automatically perform any remapping, reconfiguration, or reconnection of the first virtual computing resource and the one or more second virtual computing resources on the one or more servers as part of the synchronized migration.

7. The system of claim 1, wherein the first virtual computing resource and the one or more second virtual computing resources are further able to communicate using a datacenter-side communication network before, and after, the synchronized migration.

8. The system of claim 1, wherein the first limited network and the second limited network both use NVLink or Compute Express Link (CXL) communications.

9. At least one processor, comprising:
one or more logical units to:
determine, in response to a planned migration of a virtual machine, to migrate a group of virtual machines, able to communicate through a primary network and through a first limited network, to one or more servers able to communicate using the primary network and a second limited network, the second limited network being similar to the first limited network but connected to a different set of servers;
perform, after copying a preliminary portion of data for the group of virtual machines to the one or more servers, a synchronized pause of the group of virtual machines;
perform, after the synchronized pause, a transfer of the group of virtual machines to the one or more servers; and
perform, after the transfer has completed, a synchronized resume of the group of virtual machines, the group of virtual machines being allowed to continue communication using the primary network and the second limited network.

10. The at least one processor of claim 9, wherein the one or more logical units are further to:
use migration agents on individual servers to manage the copying of the preliminary portion of data, the synchronized pause, and the synchronized resume.

11. The at least one processor of claim 10, wherein the one or more logical units are further to:
use a migration manager, able to communicate with the migration agents, to initiate the migration and determine successful completion of the migration.

12. The at least one processor of claim 9, wherein the first limited network and the second limited network both use NVLink or Compute Express Link (CXL) communications.

13. The at least one processor of claim 9, wherein the one or more logical units are further to:
perform the synchronized pause after the copying of the preliminary portion of the data satisfies at least one pause criterion for all of the group of virtual machines.

14. The at least one processor of claim 13, wherein the at least one pause criterion includes at least one of a minimum amount of data transfer, a maximum amount of transfer time, or a target amount of data iterations.

15. The at least one processor of claim 9, wherein the one or more logical units are further to:
allow processing jobs, being performed by the group of virtual machines before the migration, to continue being performed by the group of virtual machines after the migration.

16. The at least one processor of claim 9, wherein the one or more logical units are further to:
automatically remap network addresses for the group of virtual machines after the migration.

17. A migration manager for a datacenter, comprising:
one or more processing units to:
determine, in response to a planned migration of at least one virtual machine, to migrate a group of virtual machines, able to communicate through a primary network and through a first limited network, to one or more servers able to communicate using the primary network and a second limited network, the second limited network being similar to the first limited network but connected to a different set of servers in the datacenter;
perform, after a synchronized pause of the group of virtual machines, transfer of the group of virtual machines to the one or more servers; and
perform, after the transfer has completed, a synchronized resume of the group of virtual machines, the group of virtual machines allowed to continue communication using the primary network and the second limited network.

18. The migration manager of claim 17, wherein the one or more processing units are further to:
copy a preliminary portion of data for the group of virtual machines to the one or more servers before performing the synchronized pause of the group of virtual machines.

19. The migration manager of claim 18, wherein the one or more processing units are further to:
pause processing jobs, being performed by the group of virtual machines, once copying of the preliminary portion of data satisfies at least one pause criterion for all virtual machines of the group, wherein the at least one pause criterion includes at least one of a minimum amount of data transfer, a maximum amount of transfer time, or a target amount of data iterations.

20. The migration manager of claim 17, wherein the first limited network and the second limited network both use NVLink or Compute Express Link (CXL) communications.
